(19) United States
(12) Patent Application Publication
(10) Pub. No.: US 2014/0319047 A1
(43) Pub. Date: Oct. 30, 2014

(54) FILTRATION MATERIAL AND METHOD FOR FABRICATING THE SAME

(71) Applicant: INDUSTRIAL TECHNOLOGY RESEARCH INSTITUTE, Hsinchu (TW)

(72) Inventors: Shu-Hui CHENG, Hsinchu County (TW); Wei-Cheng TSAI, Taipei City (TW); Shan-Shan LIN, Hsinchu City (TW); Yu-Chuan HSU, Hsinchu City (TW); Yin-Ju YANG, Hsinchu City (TW)

(73) Assignee: INDUSTRIAL TECHNOLOGY RESEARCH INSTITUTE, Hsinchu (TW)

(21) Appl. No.: 14/259,867

(22) Filed: Apr. 23, 2014

Related U.S. Application Data
(60) Provisional application No. 61/815,849, filed on Apr. 25, 2013.

(30) Foreign Application Priority Data
Jan. 10, 2014 (TW) 103100918

(51) Int. Cl. B01D 71/68; B01D 71/12; B01D 71/38; B01D 71/54; B01D 71/04; B01D 71/02; B01D 69/12; B01D 71/64

(52) U.S. Cl. CPC B01D 71/68; B01D 69/12; B01D 71/12; B01D 71/64; B01D 71/54; B01D 71/04; B01D 71/022; B01D 71/38
USPC 210/483; 210/500.27; 210/500.29; 210/500.41; 210/500.28; 210/500.39; 210/500.37; 210/500.34; 210/500.26; 210/500.25; 210/500.33; 210/500.42; 427/244; 427/462

(57) ABSTRACT

The disclosure provides a filtration material and a method for fabricating the same. The filtration material includes a supporting layer, and a composite layer, wherein the composite layer includes an ionic polymer and an interfacial polymer. Particularly, the ionic polymer and the interfacial polymer are intertwined with each other, resulting from ionic bonds formed between the ionic polymer and the interfacial polymer.

### CROSS REFERENCE TO RELATED APPLICATION

This application claims the benefit of U.S. Provisional Application No. 61/815,849, filed on Apr. 25, 2013, which provisional application is hereby incorporated herein by reference.

The application is based on, and claims priority from, Taiwan Application Serial Number 103100918, filed on Jan. 10, 2014, the disclosure of which is hereby incorporated by reference herein in its entirety.

### TECHNICAL FIELD

The technical field relates to a filtration material and a method for fabricating the same.

### BACKGROUND

Recently, filtration materials for desalination are being used for application with sea water, industrial water and wastewater. Some main goals for practitioners are for efficient salt water treatment, the reduction of operating pressure, low energy consumption, and reduced water treatment costs.

The filtration materials for desalination in the prior art are mainly made of nonporous polyester thin film. However, the nonporous polyester thin film must be operated under a higher pressure. Further, the nonporous polyester thin film has a low ion rejection rate.

Accordingly, there is a need to develop a filtration material for desalination, which is operated under a relatively lower pressure, having a high desalination efficiency, a high water flux, and a high ion rejection rate.

### SUMMARY

An embodiment of the disclosure provides a filtration material including: a supporting layer; and a composite layer disposed on the supporting layer, wherein the composite layer comprises an ionic polymer, and an interfacial polymer intertwined with each other, resulting from ionic bonds formed between the ionic polymer and the interfacial polymer.

Another embodiment of the disclosure provides a filtration material including: a supporting layer; a nanoscale fiber layer disposed on the supporting layer; and a composite layer disposed on the nanoscale fiber layer, wherein the composite layer includes an ionic polymer and an interfacial polymer, and wherein the ionic polymer and the interfacial polymer are intertwined with each other, resulting from ionic bonds formed between the ionic polymer and the interfacial polymer.

Some embodiments of the disclosure provide a method for fabricating a filtration material, including following steps. A supporting layer is provided, and a polymer layer is disposed on the supporting layer, wherein the polymer layer includes an ionic polymer. At least a part of the polymer layer is soaked in a first solution and a second solution subsequently, forming a composite layer, wherein the first solution includes a diamine compound, and the second solution includes an acyl chloride compound.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a cross section of the filtration material according to an embodiment of the disclosure.

FIGS. 2A and 2B are close-up diagrams of region 2 of the composite layer of the filtration material shown in FIG. 1.

FIGS. 3 and 4 show cross sections of the filtration material according to embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure discloses a filtration material including a supporting layer, and a composite layer disposed on the supporting layer. Since the composite layer includes an ionic polymer and an interfacial polymer intertwined with each other. Due to the ionic bonds between the ionic polymer and the interfacial polymer, the self-shrinkage of fibers of the composite layer can be achieved, resulting in reducing the pore size of the composite layer. Therefore, the filtration material of the disclosure can have a high water flux and a high ion rejection rate under a relatively lower pressure, and can serve as a ultrafiltration membrane, a desalination membrane, a nanofiltration membrane, a reverse osmosis membrane, or a forward osmosis membrane, and be applied to desalination process, seawater treatment, ultrapure water treatment, water softening, or precious metals recovery.

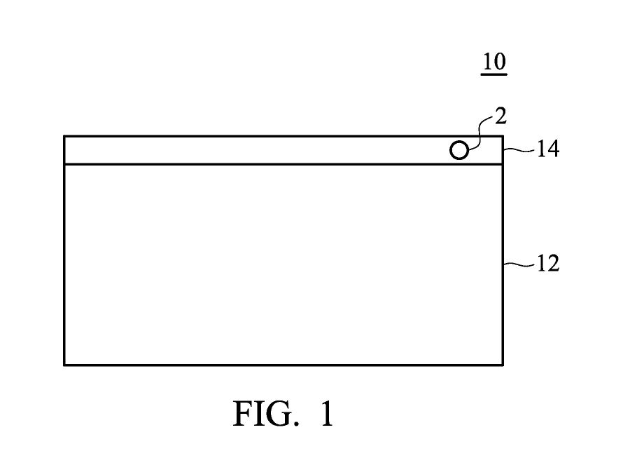

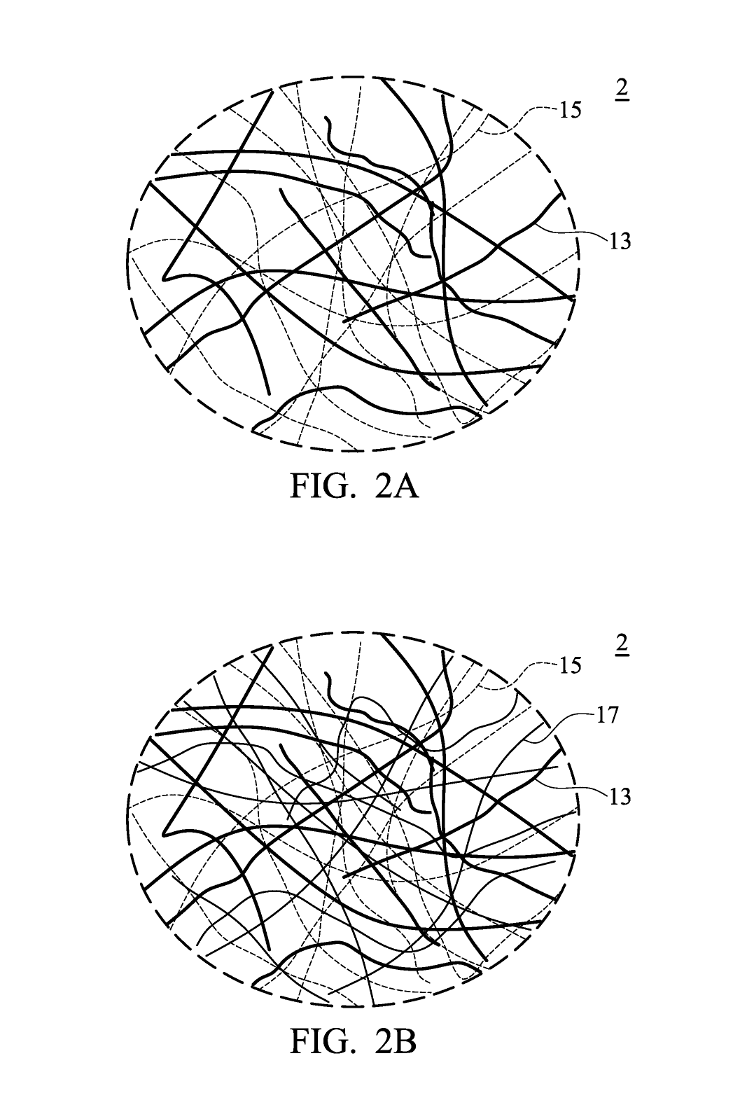

According to an embodiment of the disclosure, referring to FIG. 1, the filtration material 10 can include a supporting layer 12, and a composite layer 14 disposed on the supporting layer 12. FIG. 2A is a close-up diagram of region 2 of the composite layer 14 of the filtration material 10 shown in FIG. 1. As shown in FIG. 2A, the composite layer 14 includes an ionic polymer 13 and an interfacial polymer 15, wherein the ionic polymer 13 and the interfacial polymer 15 are intertwined with each other. Due to the ionic bonds between the ionic polymer 13 and the interfacial polymer 15, there is no obvious interface between the ionic polymer 13 and the interfacial polymer 15. According to another embodiment of the disclosure, referring to FIG. 2B (a close-up diagram of region 2 of the composite layer 14 of the filtration material 10 shown in FIG. 1), the composite layer 14 can include an ionic polymer 13, an interfacial polymer 15, and a polymer fiber 17, wherein the ionic polymer 13, the interfacial polymer 15, and the polymer fiber 17 are intertwined with each other. In particular, in the composite layer 14, the weight ratio between the ionic polymer 13 and the polymer fiber 17 is from 1:99 to 99:1.

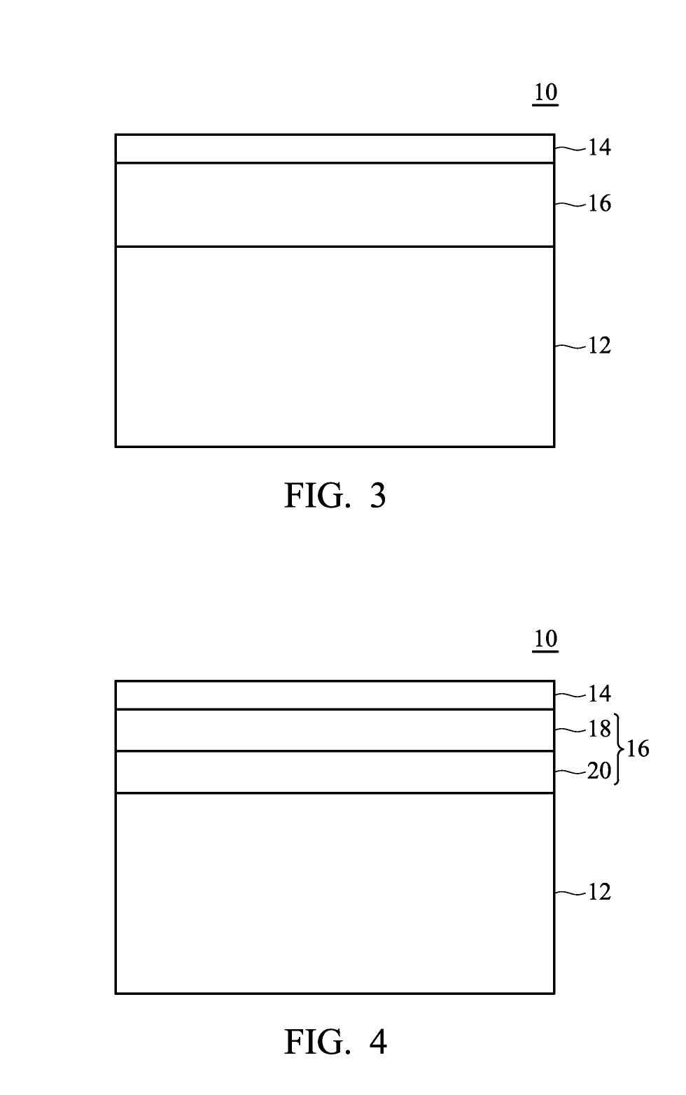

According to other embodiments of the disclosure, referring to FIG. 3, the filtration material 10 can include a supporting layer 12, a nanoscale fiber layer 16 disposed on the supporting layer 12, and a composite layer 14 disposed on nanoscale fiber layer 16, wherein the composite layer 14 can include an ionic polymer 13 and an interfacial polymer 15 intertwined with each other. The nanoscale fiber layer 16 consists of an ionic polymer, wherein the material of the ionic polymer 13 of the nanoscale fiber layer 16 is the same as that of the ionic polymer 13 of the composite layer 14. Further, according to another embodiment of the disclosure, the nanoscale fiber layer 16 consists of an ionic polymer 13 and a polymer fiber 17, wherein the weight ratio between the ionic polymer 13 and the polymer fiber 17 is from 1:99 to 99:1. It should be noted that the material of the ionic polymer 13 of the nanoscale fiber layer 16 is the same as that of the ionic polymer 13 of the composite layer 14.

According to some embodiments of the disclosure, referring to FIG. 4, the filtration material 10 can include a supporting layer 12, a nanoscale fiber layer 16 disposed on the supporting layer 12, and a composite layer 14 disposed on the nanoscale fiber layer 16, wherein the composite layer 14 can include an ionic polymer 13, and an interfacial polymer 15 intertwined with each other. The nanoscale fiber layer 16 is a laminated layer including an ionic polymer layer 18 and a polymer fiber layer 20, wherein the ionic polymer layer 18 directly contacts with the composite layer 14, and the polymer fiber layer 20 directly contacts with the supporting layer 12. Particularly, the material of the ionic polymer layer 18 is the same as that of the ionic polymer 13 of the composite layer 14.

The filtration material for desalination of the disclosure may additionally be combined with other conventional permeable, semi-permeable membranes or other polymer films according to actual application.

The supporting layer of the disclosure can be a non-woven fabric fiber supporting layer, wherein the fibers of the non-woven fabric fiber supporting layer have a diameter between 500 nm and 50 μm. According to another embodiment of the disclosure, the supporting layer has a thickness between 1 μm and 500 μm, and the material of the supporting layer can be cellouse ester, polysulfone, polypropylene (PP), polyetheretherketone (PEEK), polyester, polyethylene terephthalate (PET), polyimide (PI), polyurethane, chlorinated polyvinyl chloride (CPVC), styrene acrylnitrile (SAN), glass fiber, inorganic fiber, metal fiber, or combinations thereof.

The composite layer of the disclosure can have a thickness between 50 nm and 500 nm. The ionic polymer of the disclosure has a repeat unit of

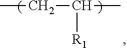

a repeat unit of

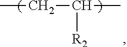

and a repeat unit of

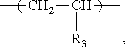

wherein R₁ is benzenesulfonic acid group or alkylsulfonic acid group; R₂ is imidazolyl (

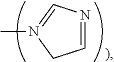

or pyridyl (

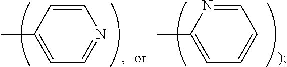

and, R₃ is phenyl, or methoxycarbonyl. Particularly, the repeat unit of

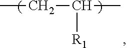

the repeat unit of

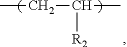

and the repeat unit of

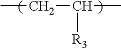

are arranged in an irregular or intermittent order. According to some embodiments of the disclosure, the above ionic polymer can have an average molecular weight between 300 and 1000000.

The interfacial polymer of the disclosure can be prepared by reacting a diamine compound with an acyl chloride compound via polymerization. Particularly, the diamine compound can be triaminobenzene, p-phenylene diamine, m-phenylene diamine, 1,4-diaminocyclohexane, 1,2-diaminocyclohexane, N,N-diphenylethylene diamine, piperazine, trimethylene dipiperidine, m-xylene diamine, 5-methylnonane-1,9-diamine, carbonyl diamine, 2,2-(ethylenedioxy)bis(ethylamine), or combinations thereof. Further, the acyl chloride compound can be trimesoyl chloride (TMC), terephthalloyl chloride (TPC), or combinations thereof.

According to an embodiment of the disclosure, in the composite layer, there are ionic bonds between the ionic polymer and the interfacial polymer, and the ionic bonds exist between the nitrogen atom of the R₂ group of the ionic polymer (having the repeat unit of

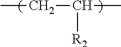

) and the chlorine atom of the interfacial polymer (prepared by reacting the diamine compound and the acyl chloride compound via polymerization).

The nanoscale fiber layer of the disclosure has a thickness of between 50 nm and 50 μm. Further, the fibers of the polymer fiber layer of the disclosure can have an average diameter between 2 nm and 800 nm, wherein the material of the polymer fiber layer can be polyurethane (PU), polyvinyl alcohol (PVA), polyacrylonitrile (PAN), polyethersulfone (PES), polyvinylidene fluoride (PVDF), polyolefin, polysulfone, polyester, polyamide, polycarbonate, polystyrene, polyacrylamide, polyacrylate, polymethyl methacrylate, polysaccharide, or combinations thereof. Further, the method for forming the polymer fiber layer can be solution spinning, or electrospinning.

The disclosure provides a method for fabricating the aforementioned filtration material. According to an embodiment of the disclosure, the method for fabricating the aforementioned filtration material can include the following steps. First, a supporting layer is provided, wherein a polymer layer is disposed on the supporting layer, wherein the polymer layer includes an ionic polymer. Next, the polymer layer is soaked in a first solution and a second solution subsequently, forcing the polymer layer to convert into a composite layer via interfacial polymerization. Since the first solution includes a diamine compound and the second solution includes an acyl chloride compound, the composite layer is constituted by the ionic polymer and an interfacial polymer intertwined with each other, wherein the interfacial polymer is prepared by reacting the diamine compound and the acyl chloride compound via polymerization. Further, there are ionic bonds formed between the ionic polymer and the interfacial polymer.

The method for preparing the first solution includes dissolving a diamine compound in water, wherein the concentration of the diamine compound is about 0.1-30 wt %, based on the weight of the first solution. The first solution can include a methanol, ethanol, isopropanol, or n-butanol. Further, the method for preparing the second solution includes dissolving an acyl chloride compound in an organic solvent, wherein the concentration of the acyl chloride compound is about 0.1-1 wt %, based on the weight of the second solution. The organic solvent can be hexane, 1,1,2-trichloro-1,2,2-trifluoroethane, pentane, or heptane.

It should be noted that the whole polymer layer can be soaked in the first solution and then the second solution. Therefore, after an interfacial polymerization, the whole polymer layer converts into the composite layer, obtaining the filtration material as shown in FIG. 1. Further, according to other embodiments of the disclosure, a part of the polymer layer can be soaked in the first and second solutions, and converts into the composite layer. The other part of the polymer layer (not soaked in the first solution and the second solution) is defined as the nanoscale fiber layer 16 as shown in FIG. 3.

On the other hand, the polymer can further include a polymer fiber, forcing the composite layer to be constituted by the polymer fiber, the ionic polymer, the interfacial polymer intertwined with each other, as shown in FIG. 2B. Herein, the polymer layer can be formed by solution spinning, or electrospinning with the ionic polymer and the polymer fiber serving as starting materials.

According to some embodiments of the disclosure, the polymer layer is a laminated layer including an ionic polymer layer and a polymer fiber layer, wherein the polymer fiber layer is disposed between the ionic polymer layer and the supporting layer. Therefore, when a part of the polymer layer (such as the ionic polymer layer) is soaked in the first solution and the second solution, the part of the polymer layer (soaked in the first solution and the second solution) converts into the composite layer, and the other part of the polymer layer (not soaked in the first solution and the second solution, such as the polymer fiber layer) is defined as the nanoscale fiber layer as shown in FIG. 4.

Below, exemplary embodiments will be described in detail with reference to accompanying drawings so as to be easily realized by a person having ordinary knowledge in the art. The disclosure concept may be embodied in various forms without being limited to the exemplary embodiments set forth herein. Descriptions of well-known parts are omitted for clarity, and like reference numerals refer to like elements throughout.

Ionic Polymer

### Preparation Example 1

10 g of sodium styrenesulfate, 40 g of 4-vinyl pyridine, 7 g of styrene, 50 g of deionized water and 50 g of isopropanol (IPA) were added to a reaction flask, and stirred under N₂ atmosphere at 70° C. A solution containing 0.2 g of potassium persulfate (KPS) in 10 mL of the deionized water was slowly added into the reaction flask, and stood for 3 hours. The mixture was purified to obtain the ionic polymer (polyE) with a yield of 88% and an average molecular weight of 136784.

Composite Structure

### Preparation Example 2

The ionic polymer (polyE) obtained from Preparation Example 1 was dissolved in N,N-dimethyl-acetamide (DMAc) to provide a spinning solution (with a solid content of 18%). Next, a net polymer layer (with a thickness 10 μm and a fiber diameter between 80 and 500 nm) was formed on a supporting layer (PET non-woven fabric fiber supporting layer, with a thickness of 110 μm) by electrospinning the spinning solution, obtaining the composite structure (1).

### Preparation Example 3

30 g of the ionic polymer (polyE) obtained from Preparation Example 1 and 30 g of polyacrylonitrile (PAN) (commercially available from Tong-Hwa Synthetic Fiber Co. Ltd., having an average molecular weight of 240000 g/mol) were dissolved in N,N-dimethyl-acetamide (DMAc) to provide a spinning solution, wherein the weight ratio of polyE and PAN is 1:1. Next, a net polymer layer (with a thickness 10 μm and a fiber diameter between 80 and 500 nm) was formed on a supporting layer (PET non-woven fabric fiber supporting layer, with a thickness of 110 μm) by electrospinning the spinning solution, obtaining the composite structure (2).

### Preparation Example 4-7

Preparation examples 4-7 were performed in the same way as Example 3 except that the weight ratio of polyE and PAN was changed from 1:1 to 1:1.25, 1:1.65, 1:2, and 1:2.5 respectively, obtaining the composite structures (3)-(6).

### Preparation Example 8

Polyacrylonitrile (PAN) (commercially available from Tong-Hwa Synthetic Fiber Co., Ltd., having an average molecular weight of 240000 g/mol) was dissolved in N,N-dimethyl-acetamide (DMAc) to provide a spinning solution. Next, a net polymer layer (with a thickness 10 μm and a fiber diameter between 80 and 500 nm) was formed on a supporting layer (PET non-woven fabric fiber supporting layer, with a thickness of 110 μm) by electrospinning the spinning solution, obtaining the composite structure (7).

### Preparation Example 9

Polyacrylonitrile (PAN) (commercially available from Tong-Hwa Synthetic Fiber Co., Ltd., having an average molecular weight of 240000 g/mol) was dissolved in N,N-dimethyl-acetamide (DMAc) to provide a spinning solution. Next, a PAN layer (with a thickness 10 μm and a fiber diameter between 80 and 500 nm) was formed on a supporting layer (PET non-woven fabric fiber supporting layer, with a thickness of 110 μm) by electrospinning the spinning solution. Next, a net polymer layer was formed on the PAN layer by electrospinning the spinning solution disclosed in Preparation Example 3 (including PolyE and PAN), obtaining the composite structure (8).

### Preparation Example 10

Polyurethane (PU) (commercially available from Kuo-Ching Chem. Co. with a trade No. of KC58238AU, having an average molecular weight of 200000 g/mol) was dissolved in N,N-dimethyl-acetamide (DMAc) to provide a spinning solution. Next, a PU layer (with a thickness 10 μm) was formed on a supporting layer (PET non-woven fabric fiber supporting layer, with a thickness of 110 μm) by electrospinning the spinning solution. Next, a net polymer layer was formed on the PU layer by electrospinning a spinning solution including PolyE and PU (the weight ratio of the PolyE and PU is 1:1), obtaining the composite structure (9).

### Preparation Example 11

Polyimide (PI) (commercially available from GE Plastics with a trade No. of Ultem) was dissolved in N,N-dimethyl-acetamide (DMAc) to provide a spinning solution. Next, a PI layer (with a thickness 10 μm) was formed on a supporting layer (PET non-woven fabric fiber supporting layer, with a thickness of 110 μm) by electrospinning the spinning solution. Next, a net polymer layer was formed on the PI layer by electrospinning a spinning solution including PolyE and PI (the weight ratio of the PolyE and PI is 1:1), obtaining the composite structure (10).

Filtration Material

### Example 1

The net polymer layer of the composite structure (1) of Preparation Example 2 was soaked in an aqueous solution (MPD(m-phenylene diamine)/water with a weight ratio of 2/98) for 3 minutes. Next, the excess water of the net polymer layer was removed. Next, the net polymer layer of the composite structure (1) of Preparation Example 2 was soaked in an organic solution (TMC/hexane with a weight ratio of 0.1/100) for 30 seconds. Next, the composite structure (1) of Preparation Example 2 was placed in an oven at 70° C. for 10 minutes, resulting in that the net polymer layer converting into a composite layer. Thus, the filtration material (1) was obtained.

The composite layer of the filtration material (1) was characterised by IR-spectroscopy, and compared with the IR spectrum of the ionic polymer (PolyE) disclosed in Preparation Example 1. The result shows that there are new characteristic absorption peak sat 1639 cm⁻¹ and 1540 cm⁻¹, thereby proving that there are ionic bonds between the ionic polymer (PolyE) and the interfacial polymer (prepared by reacting the m-phenylene diamine with trimethyl benzene acyl chloride via polymerization). In more detail, the ionic bonds exist between the nitrogen atom of the pyridyl group of the ionic polymer and the chlorine atom of the acyl chloride group of the interfacial polymer. Finally, a desalination test was conducted under 30000 ppm of sodium chloride (NaCl) to measure the desalination efficiency and the flux of the filtration material (1), and the result was shown in Table 1.

### Examples 2-6

Examples 2-6 were performed in the same way as Example 1 except that the composite structure (1) was replaced by the composite structures (2)-(6) respectively, obtaining the filtration materials (2)-(6). Next, a desalination test was conducted under 30000 ppm of sodium chloride (NaCl) to measure the desalination efficiency and the flux of the filtration materials (2)-(6), and the result was shown in Table 1.

### Comparative Example 1

Comparative Example 1 was performed as Example 1 except that the composite structure (1) was replaced by the composite structure (7), obtaining the filtration material (7). Next, a desalination test was conducted under 30000 ppm of sodium chloride (NaCl) to measure the desalination efficiency and the flux of the filtration material (7), and the result was shown in Table 1.

### Example 7

A part of the net polymer layer (constituted by PolyE and PU) of the composite structure (9) of Preparation Example 10 was soaked in an aqueous solution (MPD/water with a weight ratio of 2/98) for 3 minutes. After removing the excess water of the net polymer layer, the same part of the net polymer layer of the composite structure (9) of Preparation Example 10 was then soaked in an organic solution (TMC/hexane with a weight ratio of 0.1/100) for 30 seconds. Next, the composite structure (9) of Preparation Example 10 was placed in an oven at 70° C. for 10 minutes, resulting in that the net polymer layer converted to a composite layer. Thus, the filtration material (8) was obtained. Next, a desalination test was conducted under 30000 ppm of sodium chloride (NaCl) to measure the desalination efficiency and the flux of the filtration material (8), and the result was shown in Table 1.

### Example 8

A part of the net polymer layer (constituted by PolyE and PI) of the composite structure (10) of Preparation Example 11 was soaked in an aqueous solution (MPD/water with a weight ratio of 2/98) for 3 minutes. After removing the excess water of the net polymer layer, the same part of the net polymer layer of the composite structure (10) of Preparation Example 11 was then soaked in an organic solution (TMC/hexane with a weight ratio of 0.1/100) for 30 seconds. Next, the composite structure (10) of Preparation Example 10 was placed in an oven at 70° C. for 10 minutes, resulting in that the net polymer layer converted to a composite layer. Thus, the filtration material (9) was obtained. Next, a desalination test was conducted under 30000 ppm of sodium chloride (NaCl) to measure the desalination efficiency and the flux of the filtration material (9), and the result was shown in Table 1.

TABLE 1

| | | Flux | Desalination |
|---|---|---|---|
| | | (mL/min) | efficiency (%) |
| | PAN:PolyE | | |
| filtration material (1) | 0:1 | 0.62 | 98.7 |
| filtration material (2) | 1:1 | 0.71 | 98.3 |
| filtration material (3) | 1:1.25 | 0.70 | 98.9 |
| filtration material (4) | 1:1.65 | 0.67 | 99.2 |
| filtration material (5) | 1:2 | 0.85 | 99.3 |
| filtration material (6) | 1:2.5 | 0.63 | 99.1 |
| filtration material (7) | 1:0 | 0.4 | 86.3 |
| | PU:PolyE | | |
| filtration material (8) | 1:1 | 0.65 | 98.6 |
| | PI:PolyE | | |
| filtration material (9) | 1:1 | 0.68 | 98.8 |

As shown in Table 1, the filtration material of the disclosure has a high desalination efficiency, and a high water flux. Due to the ionic bonds between the ionic polymer and the interfacial polymer, the self-shrinkage of fibers of the composite layer can be achieved, resulting in reducing the pore size of the composite layer. Therefore, the filtration material of the disclosure can serve as an ultrafiltration membrane, a desalination membrane, a nanofiltration membrane, a reverse osmosis membrane, or a forward osmosis membrane, and can be applied to a desalination process, seawater treatment, ultrapure water treatment, water softening, or precious metals recovery.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A filtration material, comprising:
a supporting layer; and
a composite layer disposed on the supporting layer, wherein the composite layer comprises an ionic polymer, and an interfacial polymer, wherein the ionic polymer and the interfacial polymer are intertwined with each other resulting from ionic bonds formed between the ionic polymer and the interfacial polymer.

2. The filtration material as claimed in claim 1, wherein the supporting layer comprises a non-woven fabric fiber supporting layer.

3. The filtration material as claimed in claim 2, wherein fibers of the non-woven fabric fiber supporting layer have a diameter between 500 nm and 50 μm.

4. The filtration material as claimed in claim 1, wherein the supporting layer comprises cellouse ester, polysulfone, polypropylene, polyetheretherketone, polyester, polyethylene terephthalate, polyimide, polyurethane, chlorinated polyvinyl chloride, styrene acrylnitrile, glass fiber, inorganic fiber, metal fiber, or combinations thereof.

5. The filtration material as claimed in claim 1, wherein the ionic polymer has a repeat unit of 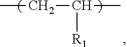
a repeat unit of 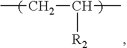
and a repeat unit of 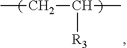
wherein the repeat unit of 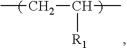
the repeat unit of 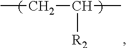
and the repeat unit of 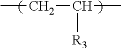
are arranged in an irregular or intermittent order, wherein R₁ is benzenesulfonic acid group or alkylsulfonic acid group; R₂ is imidazolyl ( 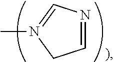
or pyridyl 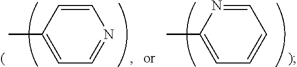
and, R₃ is phenyl or methoxycarbonyl.

6. The filtration material as claimed in claim 1, wherein the ionic polymer has an average molecular weight between 300 and 1000000.

7. The filtration material as claimed in claim 5, wherein the interfacial polymer is prepared by reacting a diamine compound with an acyl chloride compound via polymerization.

8. The filtration material as claimed in claim 7, wherein the diamine compound comprises 1,3,5-triaminobenzene, p-phenylene diamine, m-phenylene diamine, 1,4-diaminocyclohexane, 1,2-diaminocyclohexane, N,N-diphenylethylene diamine, piperazine, trimethylene dipiperidine, m-xylene diamine, 5-methylnonane-1,9-diamine, carbonyl diamine, 2,2-ethylenedioxy bisethylamine, or combinations thereof.

9. The filtration material as claimed in claim 7, wherein the acyl chloride compound comprises trimesoyl chloride, terephthalloyl chloride, or combinations thereof.

10. The filtration material as claimed in claim 1, wherein the composite layer further comprises a polymer fiber, wherein the polymer fiber, the ionic polymer, and the interfacial polymer are intertwined with each other.

11. The filtration material as claimed in claim 10, wherein the polymer fiber comprises polyurethane, polyvinyl alcohol, polyacrylonitrile, polyethersulfone, polyvinylidene fluoride, polyolefin, polysulfone, polyester, polyamide, polycarbonate, polystyrene, polyacrylamide, polyacrylate, polymethyl methacrylate, polysaccharide, or combinations thereof.

12. The filtration material as claimed in claim 10, wherein the average polymer fiber diameter is between 2 nm and 800 nm.

13. The filtration material as claimed in claim 10, wherein the polymer fiber is formed by solution spinning or electrospinning.

14. The filtration material as claimed in claim 10, wherein the weight ratio of the ionic polymer and the polymer fiber is between 1:99 and 99:1.

15. The filtration material as claimed in claim 1, further comprising:
a nanoscale fiber layer disposed between the supporting layer and the composite layer.

16. The filtration material as claimed in claim 15, wherein the nanoscale fiber layer comprises an ionic polymer.

17. The filtration material as claimed in claim 15, wherein the nanoscale fiber layer comprises an ionic polymer and a polymer fiber intertwined with each other.

18. The filtration material as claimed in claim 15, wherein the nanoscale fiber layer comprises an ionic polymer layer and a polymer fiber layer.

19. The filtration material as claimed in claim 15, wherein the nanoscale fiber layer has a thickness between 50 nm and 50 μm.

20. The filtration material as claimed in claim 7, wherein the ionic bonds exist between the nitrogen atoms of the R₂ groups of the ionic polymers and the chlorine atoms of the interfacial polymers.

21. The filtration material as claimed in claim 1, wherein the supporting layer has a thickness between 1 μm and 500 μm.

22. The filtration material as claimed in claim 1, wherein the composite layer has a thickness between 50 nm and 500 nm.

23. The filtration material as claimed in claim 1, wherein the filtration material serves as a ultrafiltration membrane, a desalination membrane, a nanofiltration membrane, a reverse osmosis membrane, or a forward osmosis membrane.

24. A method for fabricating filtration material, comprising:
providing a supporting layer, wherein a polymer layer is disposed on the supporting layer, and the polymer layer comprises an ionic polymer; and
soaking at least one part of the polymer layer into a first solution and a second solution subsequently, forcing the at least one part of the polymer layer to convert into a composite layer, wherein the first solution comprises a diamine compound, and the second solution comprises an acyl chloride compound.

25. The method for fabricating filtration material as claimed in claim 24, wherein the composite layer comprises the ionic polymer and an interfacial polymer intertwined with each other, wherein the interfacial polymer is formed by polymerizing the diamine compound and the acyl chloride compound, and wherein ionic bonds are formed between the ionic polymer and the interfacial polymer.

26. The method for fabricating filtration material as claimed in claim 24, wherein a part of the polymer layer is soaked in the first solution and the second solution, and the other part of the polymer layer, which is not soaked in the first solution and the second solution, is defined as a nanoscale fiber layer.

27. The method for fabricating filtration material as claimed in claim 24, wherein the polymer layer further comprises a polymer fiber, and the composite layer comprises the polymer fiber, the ionic polymer, and the interfacial polymer intertwined with each other.

28. The method for fabricating filtration material as claimed in claim 27, wherein the polymer layer is formed by solution spinning, or electrospinning with the ionic polymer and the polymer fiber as starting materials.

29. The method for fabricating filtration material as claimed in claim 24, wherein the polymer layer comprises an ionic polymer layer and a polymer fiber layer, wherein the polymer fiber layer is disposed between the ionic polymer layer and the supporting layer.

30. The method for fabricating filtration material as claimed in claim 24, wherein the supporting layer comprises a non-woven fabric fiber supporting layer.

31. The method for fabricating filtration material as claimed in claim 24, wherein fibers of the non-woven fabric fiber supporting layer have a diameter between 500 nm and 50 μm.

32. The method for fabricating filtration material as claimed in claim 24, wherein the supporting layer comprises cellouse ester, polysulfone, polypropylene, polyetheretherketone, polyester, polyethylene terephthalate, polyimide, polyurethane, chlorinated polyvinyl chloride, styrene acrylnitrile, glass fiber, inorganic fiber, metal fiber, or combinations thereof.

33. The method for fabricating filtration material as claimed in claim 24, wherein the ionic polymer has a repeat unit of 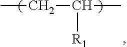
a repeat unit of 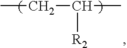
and a repeat unit of 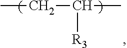
wherein the repeat unit of 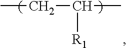
the repeat unit of 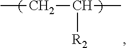
and the repeat unit of 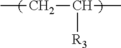
are arranged in an irregular or intermittent order, wherein R₁ is benzenesulfonic acid group or alkylsulfonic acid group; R₂ is imidazolyl ( 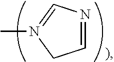
or pyridyl ( 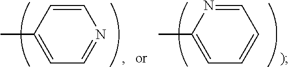
and, R₃ is b phenyl or methoxycarbonyl.

34. The method for fabricating filtration material as claimed in claim 24, wherein the ionic polymer has an average molecular weight between 300 and 1000000.

35. The method for fabricating filtration material as claimed in claim 24, wherein the diamine compound comprises 1,3,5-triaminobenzene, p-phenylene diamine, m-phenylene diamine, 1,4-diaminocyclohexane, 1,2-diaminocyclohexane, N,N-diphenylethylene diamine, piperazine, trimethylene dipiperidine, m-xylene diamine, 5-methylnonane-1,9-diamine, carbonyl diamine, 2,2-ethylenedioxy bisethylamine, or combinations thereof.

36. The method for fabricating filtration material as claimed in claim 24, wherein the acyl chloride compound comprises trimesoyl chloride, terephthalloyl chloride, or combinations thereof.

37. The method for fabricating filtration material as claimed in claim 27, wherein the polymer fiber comprises polyurethane, polyvinyl alcohol, polyacrylonitrile, polyethersulfone, polyvinylidene fluoride, polyolefin, polysulfone, polyester, polyamide, polycarbonate, polystyrene, polyacrylamide, polyacrylate, polymethyl methacrylate, polysaccharide, or combinations thereof.

38. The method for fabricating filtration material as claimed in claim 27, wherein fibers of the polymer fiber have an average diameter between 2 nm and 800 nm.

39. The method for fabricating filtration material as claimed in claim 27, wherein the weight ratio of the ionic polymer and the polymer fiber is between 1:99 and 99:1

40. The method for fabricating filtration material as claimed in claim 24, wherein the supporting layer has a thickness between 1 μm and 500 μm.

41. The method for fabricating filtration material as claimed in claim 24, wherein the composite layer has a thickness between 50 nm and 500 nm.

42. A filtration material, comprising:
a supporting layer;
a nanoscale fiber layer disposed on the supporting layer; and
a composite layer disposed on the nanoscale fiber, wherein the composite layer comprises an ionic polymer and an interfacial polymer intertwined with each other, resulting from ionic bonds formed between the ionic polymer and the interfacial polymer.

43. The filtration material as claimed in claim 42, wherein the nanoscale fiber layer comprises an ionic polymer.

44. The filtration material as claimed in claim 42, wherein the nanoscale fiber layer comprises an ionic polymer and a polymer fiber intertwined with each other.
